(19) United States
(12) Patent Application Publication
(10) Pub. No.: US 2012/0208952 A1
(43) Pub. Date: Aug. 16, 2012

(54) Method for Deaerating Liquids

(75) Inventors: Willibald Burger, Burghausen (DE); Ludwig Esterbauer, Ampfing (DE); Holger Rautschek, Nunchritz (DE)

(73) Assignee: Wacker Chemie AG, Munich (DE)

(21) Appl. No.: 13/500,741

(22) PCT Filed: Sep. 29, 2010
(86) PCT No.: PCT/EP2010/064466

§ 371 Date: Apr. 6, 2012

(30) Foreign Application Priority Data
Oct. 6, 2009 (DE) 10 2009 045 365.2

(51) Int. Cl. C08L 83/04

(52) U.S. Cl. 524/588

(57) ABSTRACT

The invention describes a novel method for deaerating liquids by adding 0.0001 to 5.0% by weight, preferably 0.0002-1.0% by weight, especially preferred 0.001-0.2% by weight of branched polyether-polysiloxane copolymers to said liquids. Only those branched polyether-polysiloxane copolymers are used in which the polyether radicals are SiC-bonded via hydrocarbon radicals to linear siloxane chains and said siloxane chains are connected to each other via SiC-bonded organic radicals, preferably divalent to decavalent, preferably divalent to tetravalent, hydrocarbon radicals, which may contain one or more heteroatoms selected from the group consisting of oxygen and nitrogen atoms.

### CROSS REFERENCE TO RELATED APPLICATIONS

This application is the national phase filing of international patent application No. PCT/EP2010/064466, filed Sep. 29, 2010, and claims priority of German patent application number 10 2009 045 365.2, filed Oct. 6, 2009, the entireties of which applications are incorporated herein by reference.

### FIELD OF THE INVENTION

The invention relates to a method for deaerating liquids, especially for deaerating aqueous suspensions as generated for example in textile treatment or chemical-pulp and paper production.

### BACKGROUND OF THE INVENTION

There are many liquid, especially aqueous, systems containing surface-active compounds as desired or else undesired constituents where problems can arise with entrapped air bubbles when these systems come into more or less intensive contact with gaseous entities, for example in the sparging of wastewaters, in the intensive stirring of liquids, in distillation, washing or dyeing processes. Especially liquids containing finely divided particles such as, for example, fibers, which can attract air bubbles, tend to entrap air.

In chemical-pulp production, entrapped air is for example a hindrance to rapid drainage of the water and thus reduces quality and productivity.

Conventional defoamers, as will be known, are suitable for controlling “dry” surface foam where large gas bubbles are separated by thin films of liquid (as described in Langmuir 2004, 20, 9463-9505). They have no efficacy in respect of deaerating liquid-gas mixtures consisting mostly of liquid with or without suspended solids.

This is because the surface properties and the solubility of defoamers that destroy the surface foam, also known as macrofoam, necessarily differ from the properties of deaerators (see Adams, J. W. et al. Verfkroniek, 68 (10) 1996 pp. 43-45). Defoamers have to be incompatible and rapidly migrate to the surface. Deaerators designed to control microfoam, by contrast, have to be more compatible, since they are intended to act in the liquid phase and not at the surface. Therefore, it is not possible to infer that a good defoamer is also a deaerator (cf. EP 257 356 B1, page 2, lines 28-31).

Specific formulations are therefore proposed for these applications. GB 2 350 117 A proposes achieving better deaeration by using linear or cyclic siloxanes bearing polyether groups attached Si—C or Si—O—C. EP 257 356 B1 claims siloxanes having (isobutyryloxy)isopropyldimethylpropoxy groups, which are said to enable better deaeration of plastisols than polyether siloxanes.

WO 2006/128624 A1, EP 1 424 117 A2 and EP 1 076 073 A1 describe defoamer formulations containing
(A) antifoam agents based on siloxanes, and
(B) polyether-polysiloxane copolymers.

There continues to be a need for better deaerating agents for various applications, especially for the production of chemical pulp.

### SUMMARY OF THE INVENTION

It was found that, surprisingly, specific branched polyether-polysiloxane copolymers have a superior deaerating effect.

### DETAILED DESCRIPTION OF THE INVENTION

The invention provides a method for deaerating liquids by addition of 0.0001 to 5.0 wt %, preferably 0.0002-1.0 wt % and more preferably 0.001-0.2 wt % of branched polyether-polysiloxane copolymers to these liquids, said method comprising utilizing branched polyether-polysiloxane copolymers wherein the polyether moieties are attached to linear siloxane chains via hydrocarbon moieties, preferably divalent hydrocarbon moieties, in SiC bonding and these siloxane chains are connected to each other via SiC-bonded organic moieties, preferably two- to ten-valent and more preferably two- to four-valent hydrocarbon moieties which may contain one or more heteroatoms selected from the group of oxygen and nitrogen atoms.

Preference is given to using branched polyether-poly-siloxane copolymers of the present invention which have linear siloxane chains connected to each other via lateral linear or branched SiC-bonded organic moieties, preferably linear SiC-bonded organic moieties, or have linear siloxane chains bonded to each other terminally via branched organic moieties.

Examples of organic moieties where linear siloxane chains are bonded to each other via lateral linear or branched SiC-bonded organic moieties are SiC-bonded divalent hydrocarbon moieties, such as alkylene moieties, SiC-bonded polyether moieties which are attached to the siloxane chains via divalent hydrocarbon moieties, such as alkylene moieties, and SiC-bonded divalent hydrocarbon moieties, such as alkylene moieties, which contain polyether and urethane groups.

Examples of organic moieties where linear siloxane chains are bonded to each other terminally via branched organic moieties are SiC-bonded branched trivalent hydrocarbon moieties, such as a moiety of the formula

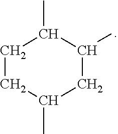

The polyether-polysiloxane copolymers of the present invention have a viscosity of preferably 100 to 100 000 000 mPa·s at 25° C., more preferably 1000 to 1 000 000 mPa·s at 25° C. and even more preferably 1000 to 100 000 mPa·s at 25° C.

The branched polyether-polysiloxane copolymers used are preferably those copolymers (B1) which are obtainable by a first step of

reacting linear organopolysiloxanes (1), which have at least one Si-attached hydrogen atom and preferably at least two Si-attached hydrogen atoms per molecule, with substantially linear oligomeric or polymeric compounds (2) of the general formula

R¹−(O—CₙH₂ₙ)ₘ−A¹—H (I)

where R¹ is a monovalent optionally substituted hydro-carbon moiety onto which Si—H groups may be added in a hydrosilylation reaction, preferably a hydrocarbon moiety having an aliphatic C-C multiple bonding, A¹ is a divalent polar organic moiety selected from the group —O—, —NH— and —NR′— (where R′ is a monovalent hydrocarbon moiety with 1 to 18 carbon atoms), preferably an oxygen atom —O—,
n is an integer from 1 to 20, preferably 1 to 4 and more preferably 2 or 3, and
m is a positive integer, preferably from 5 to 50, and a second step of
reacting the thus obtained H—A¹-containing intermediates (4) with organic compounds (5) having at least two isocyanate groups per molecule,
with the proviso that the water content of said compounds (1) and (2) used for preparing the polysiloxane copolymers is less than 2000 wt ppm, preferably less than 1500 wt ppm and more preferably less than 1000 wt ppm, all based on the overall weight of compounds (1) and (2).

In the branched polyether-polysiloxane copolymers (B1) which are used according to the present invention, the linear siloxane chains are bonded to each other via lateral linear or branched organic moieties, preferably linear organic moieties, wherein the organic moieties are SiC-bonded divalent hydrocarbon moieties, such as alkylene moieties, which contain polyether and urethane groups.

Preference for use as organopolysiloxanes (1) is given to those of the general formula

H_{g}R_{3-g}SiO(SiR₂O)ₒ(SiRHO)ₚSiR_{3-g}H_{g} (III)

where R in each occurrence may be the same or different and is a monovalent, optionally halogenated hydrocarbon moiety having 1 to 18 carbon atoms per moiety,
g is 0, 1 or 2,
o is 0 or an integer from 1 to 1500, and
p is an integer from 1 to 200,
with the proviso that each molecule contains at least one Si-attached hydrogen atom and preferably at least two Si-attached hydrogen atoms.

Preferably, g in formula (III) is 0 and p in formula (III) is from 2 to 50 and more preferably 3-20 and especially 5-10, and the organopolysiloxanes (1) preferably comprise copolymers composed of hydrogen-alkylsiloxy and dialkylsiloxy units, especially copolymers composed of hydrogenmethylsiloxy and dimethylsiloxy units.

Examples of R moieties are alkyl moieties, such as methyl, ethyl, n-propyl, isopropyl, 1-n-butyl, 2-n-butyl, isobutyl, tert-butyl, n-pentyl, isopentyl, neopentyl, tert-pentyl, hexyl, such as n-hexyl, heptyl, such as n-heptyl, octyl, such as n-octyl and isooctyl, such as 2,2,4-trimethylpentyl, nonyl, such as n-nonyl, decyl, such as n-decyl, dodecyl, such as n-dodecyl, and octadecyl, such as n-octadecyl; cycloalkyl moieties, such as cyclopentyl, cyclohexyl, cycloheptyl and methyl-cyclohexyl; aryl moieties, such as phenyl, naphthyl, anthryl and phenanthryl; alkaryl moieties, such as o-, m-, p-tolyl moieties, xylyl moieties and ethylphenyl moieties; and aralkyl moieties, such as benzyl, α-phenylethyl and β-phenylethyl.

Examples of halogenated R moieties are haloalkyl moieties, such as 3,3,3-trifluoro-n-propyl, 2,2,2,2′,2′,2′-hexafluoroisopropyl, heptafluoroisopropyl and haloaryl moieties, such as o-chlorophenyl, m-chlorophenyl and p-chlorophenyl.

R is preferably a monovalent hydrocarbon moiety with 1 to 6 carbon atoms and more preferably methyl.

Examples of R¹ moieties are alkenyl moieties, such as vinyl, 5-hexenyl, cyclohexenyl, 1-propenyl, allyl, 3-butenyl and 4-pentenyl, and alkynyl moieties, such as ethynyl, propargyl and 1-propynyl.

R¹ is preferably an alkenyl moiety, especially ω-alkenyl, in which case allyl is particularly preferred.

Preference for use as oligomeric or polymeric compounds (2) is given to polyethers of the general formula

H₂C═CH—R²—(OCₙH₂ₙ)ₘ—OH (IV)

where R² is a divalent hydrocarbon moiety with 1 to 10 carbon atoms, preferably a moiety of the formula —CH₂—, —CH(CH₃)— or —C(CH₃)₂—, and
n and m are each as defined above.

Preferred examples of polyethers (2) are those of the general formula

H₂C═CH—R²-(OCH₂CH₂)ₐ[OCH₂CH(CH₃)]_{b}-OH (IV′)

where R² is as defined above and a and b are each 0 or an integer from 1 to 200 and preferably from 5 to 50.

The amounts in which compounds (2) are used in the first process step are preferably from 1.0 to 4.0 and more preferably from 1.3 to 2.5 mol of the R¹ moiety, which is preferably a moiety with 1 aliphatic C-C multiple bonding, preferably an ω-alkenyl moiety, per mole of Si-attached hydrogen in organopolysiloxane (1).

The first process step preferably utilizes catalysts (3) to promote the addition of Si-attached hydrogen onto aliphatic multiple bonding. Useful catalysts (3) for the method of the present invention include the same catalysts as previously used for promoting the addition of Si-attached hydrogen onto aliphatic multiple bonding. The catalysts preferably comprise a metal from the group of platinum metals, or a compound or complex from the group of platinum metals. Examples of such catalysts are metallic and finely divided platinum, which may be on carriers, such as silicon dioxide, aluminum oxide or activated carbon; compounds or complexes of platinum, such as platinum halides, e.g., PtCl₄, H2PtC16*6H2O, Na2PtCl_{4*4}H2O, platinum-olefin complexes, platinum-alcohol complexes, platinum-alkoxide complexes, platinum-ether complexes, platinum-aldehyde complexes, platinum-ketone complexes, including reaction products formed from H2PtCl6*6H2O and cyclohexanone, platinum-vinyl-siloxane complexes, such as platinum-1,3-divinyl-1,1,3,3-tetramethyldisiloxane complexes with or without presence of detectable inorganically bound halogen, bis(gamma-picoline) platinum dichloride, trimethylenedipyridine-platinum dichloride, dicyclopentadieneplatinum dichloride, dimethylsulfoxideethyleneplatinum(II) dichloride, cyclooctadieneplatinum dichloride, norbornadieneplatinum dichloride, gamma-picoline-platinum dichloride, cyclopentadieneplatinum dichloride, and also reaction products of platinum tetrachloride with olefin and primary amine or secondary amine or primary and secondary amine, such as the reaction product formed from 1-octene-dissolved platinum tetrachloride with sec-butylamine, or ammonium-platinum complexes.

The amounts in which catalyst (3) is used in the first process step are preferably in the range from 1 to 50 wt ppm (parts by weight per million parts by weight) and more preferably in the range from 2 to 20 wt ppm, all reckoned as elemental platinum and based on the overall weight of organopolysiloxanes (1) and compounds (2).

The first process step is preferably performed at ambient pressure, i.e., approximately at 1020 hPa (abs.), but it can also be carried out at higher or lower pressures. Furthermore, the first process step is preferably performed at a temperature of 60° C. to 140° C., preferably 80° C. to 120° C.

Organic compounds (5) used in the second process step as having at least two isocyanate groups per molecule are preferably diisocyanates of the general formula

O═C═N—R³—N═C═O (V)

where R³ is a divalent hydrocarbon moiety having 4 to 40 carbon atoms per moiety.

Examples of organic compounds (5) are 1,6-hexamethylene diisocyanate, isophorone diisocyanate, 2,4-tolylene diisocyanate, 2,6-tolylene diisocyanate, 1,3-phenylene diisocyanate, 4,4′-methylenebis(cyclohexylisocyanate), 4,4′-methylenebis(phenyl isocyanate) and dimethylphenyl diisocyanate.

The amounts in which organic compounds (5) are used in the second process step are preferably in the range from 0.1 to 0.9 mol and more preferably in the range from 0.2 to 0.7 mol of isocyanate group per mole of H—A¹ group in intermediate (4).

The reaction in the second step of the method according to the present invention preferably utilizes condensation catalysts (6), such as di-n-butyltin dilaurate, tin(II) octoate, dibutyltin diacetate, potassium octoate or tertiary amines, such as dimethylcyclohexylamine, dimethylaminopropyldipropanolamine, pentamethyldipropylenetriamine, N-methylimidazole or N-ethylmorpholine.

A preferred polysiloxane copolymer is obtained on reacting, in the first process step, a methyl-terminated hydrogen-functional polysiloxane (1), that has laterally Si-attached hydrogen atoms, with an excess of polyether (2) of formula (IV) and, in the second process step, the intermediate (4), a comb-structured silicone polyether, with a diisocyanate (5) of formula (V), whereby urethane groups are introduced into the polysiloxane copolymer. Free polyether from the 1^{st} step also becomes bound by urethane formation.

The second step of the method according to the present invention, in addition to organic compounds (5), may utilize still further compounds (7) that are reactive toward isocyanate groups.

The second process step is preferably performed at ambient pressure, i.e., approximately at 1020 hPa (abs.), but it can also be carried out at higher or lower pressures. Furthermore, the second process step is preferably performed at a temperature of 40° C. to 160° C., preferably 80° C. to 140° C.

To reduce the partly very high product viscosities, low molecular substances, such as alcohols or ethers can be added if desired.

The polyether-polysiloxane copolymers (B1) and their preparation are described in WO 2006/128624 A1, especially at page 3 line 8 to page 13 line 38 (incorporated by reference).

Preference for use as branched polyether-polysiloxane copolymers is given to those copolymers (B2) which contain structural elements of the general formula

Y[—C_{n′}H_{2n′}-(R₂SiO)_{m′}-A′_{p′}-R₂Si-G]_{x′} (I′)

where
Y is a three- to ten-valent and preferably three- to four-valent hydrocarbon moiety which may contain one or more heteroatoms selected from the group of oxygen and nitrogen atoms,
R is as defined above,
A′ is a moiety of the formula —R₂Si—R^{2′}-(R₂SiO)_{m′}—, where R²′ is a divalent hydrocarbon moiety which has 2 to 30 carbon atoms and which may be interrupted by one or more mutually separate oxygen atoms, preferably 1 to 4 mutually separate oxygen atoms,
G is a monovalent moiety of the formula —C_{f′}H_{2f′-2k′}—Z or a divalent moiety of the formula —C_{n′}H_{2n′}—, where the second bond goes to a further Y moiety,
Z is a moiety of the formula —(R^{6′})_{v′}-(OCH₂CH₂)_{a′}[OCH₂CH (CH₃) ]_{b′}[OCH₂CH (CH₂CH₃) ]_{c′}—OR^{3′}where R^{3′} is a hydrogen atom or a hydrocarbon moiety with 1 to 18 carbon atoms or a moiety of the formula R-C(O)— (where R is as defined above),

R^{6′} is a divalent hydrocarbon moiety with 1 to 10 carbon atoms,

v′ is 0 or 1, preferably 1,

a′, b′ and c′ are each 0 or an integer between 1 and 1000, and c′ is preferably 0, with the proviso that the sum of (a′+b′+c′) has a value of 2 to 2000, preferably from 2 to 200 and more preferably from 2 to 150,

x′ is an integer from 3 to 10, preferably 3 or 4,

f′ is an integer from 2 to 12, preferably 2,
k′ is 0 or 1, preferably 0,
n′ is an integer from 2 to 12, preferably 2,
m′ is an integer of at least 1, preferably an integer from 1 to 1000, and
p′ is 0 or a positive integer, preferably 0 or an integer from 1 to 20,
with the proviso that the branched polyether-polysiloxane copolymers (B2) contain on average at least one Z group.

The branched polyether-polysiloxane copolymers (B2) of the general formula (I′) are preferably prepared by reacting in a first step

compounds (1′) which have at least three aliphatic double bonds and the formula

Y(CR^{1′}=CH₂)_{x′}

where Y and x′ are each as defined above and R^{1′} is a hydrogen atom or an alkyl moiety with 1 to 10 carbon atoms, preferably a hydrogen atom,
with organopolysiloxanes (2′) of the general formula

H(R₂SiO)_{m′}-A′_{p′}-R₂SiH

where A′, R, m′ and p′ are each as defined above, in the presence of catalysts (3′) that promote the addition of Si-attached hydrogen onto aliphatic multiple bonding, i.e., in the presence of a so-called hydrosilylation catalyst,
and in a second step, the thus obtained branched intermediates (5′) which have Si-attached hydrogen atoms with organic compounds (4′) of the formula

C_{f′}H_{2f′-2k′-1}-Z

selected from the group of
when k′=0: H₂C═CR^{4′}-Z (4a′) and
when k′=1: R^{5′}C≡C—Z (4b′)
where R^{4′} and R^{5′} each have the meanings of R^{1′} and are each preferably a hydrogen atom,
f′, k′ and Z are each as defined above,
in the presence of catalysts (3′) that promote the addition of Si-attached hydrogen onto aliphatic multiple bonding.

It is preferable for k′ to be 0 and organic compounds (4a′) are accordingly preferable.

The branched-structure polyether-polysiloxane copolymers (B2) used according to the present invention contain in principle chain-type siloxane blocks whose ends are each bonded via a C_{n′}H_{2n′} or C_{f′}H_{2f′-2k′} bridge to the structural elements Y and Z respectively. The greater the number of siloxane blocks bonded on both sides to Y elements, the greater the degree of branching of the products obtained. Generally, the polyether-polysiloxane copolymers (B2) of the present invention have a construction wherein siloxane blocks and organic blocks alternate with each other with the branching structures and the ends consisting of organic blocks.

In the polyether-polysiloxane copolymers (B2), the ratio of end groups Z to branching groups Y (Z/Y ratio) is preferably in the range from 1.0 to 2.0 and more preferably in the range from 1.1 to 1.5.

Examples of R moieties are specified above.

Examples in respect of hydrocarbon moieties R having 1 to carbon atoms also apply in respect of hydrocarbon moieties R^{1′}, R^{4′} and R^{5′}.

Examples in respect of hydrocarbon moieties R having 1 to carbon atoms also apply in respect of hydrocarbon moieties R^{3′}.

R^{3′} is preferably a hydrogen atom, methyl, n-butyl or acetyl.

R^{6′} is preferably of the formula —(CH₂)—.

In the first process step, the addition of the SiH group of (2′) onto the CH₂═CR^{1′} group of (1′), the so-called hydrosilylation, leads to the formation of two isomers which is familiar to a person skilled in the art.

The —C_{n′}H_{2n′} group in (I′) of copolymers (B2) according to the present invention encompasses this isomer formation and therefore preferably represents the isomeric moieties —CHR^{1′}-CH₂— of (i) and —CR^{1′}—CH₃ of (ii) and n′ is therefore the total number of carbon atoms in the CH₂═CR^{1′} group of (1′). Since R^{1′} is preferably a hydrogen atom, n′ is preferably 2.

Examples of compounds (1′) are

1,2,4-trivinylcyclohexane,
1,3,5-trivinylcyclohexane,
3,5-dimethyl-4-vinyl-1,6-heptadiene,
1,2,3,4-tetravinylcyclobutane,
methyltrivinylsilane,
tetravinylsilane,
1,1,2,2-tetraallyloxyethane,
of which 1,2,4-trivinylcyclohexane is preferred.

It is therefore preferable for the Y moiety to be of the formula

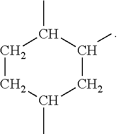

A substantially linear polymer is used as organo polysiloxane (2′).

p′ is preferably 0.

m′ is preferably an integer from 5 to 400.

The amounts in which organopolysiloxane (2′) is used in the first process step are such that the ratio of Si-attached hydrogen in organopolysiloxane (2′) to aliphatic double bonding in compound (1′) is preferably at least 1.5, more preferably in the range from 1.5 to 20 and even more preferably in the range from 1.5 to 5.0.

Since organopolysiloxane (2′) is preferably used in excess, it is accordingly the case that all aliphatic double bonds in compound (1′) react in the first process step to obtain branched intermediates (5′) having Si-attached hydrogen atoms.

Useful catalysts (3′) to promote the addition of Si-attached hydrogen onto aliphatic multiple bonding include the abovementioned catalysts (3).

The amounts in which catalyst (3′) is used in the first process step are preferably in the range from 0.2 to 20 wt ppm (parts by weight per million parts by weight) and more preferably in the range from 1 to 10 wt ppm, all reckoned as elemental platinum and based on the overall weight of compound (1′) and organopolysiloxane (2′).

The first process step is preferably performed at ambient pressure, i.e., approximately at 1020 hPa (abs.), but it can also be carried out at higher or lower pressures. Furthermore, the first process step is preferably performed at a temperature of 20° C. to 150° C., preferably 40° C. to 100° C.

Both the first and the second process step may utilize preferably inert organic solvents. Examples of inert organic solvents are toluene, xylene, octane isomers, heptane isomers, butyl acetate, 1,2-dimethoxyethane, tetrahydrofuran and cyclohexane.

The organic compounds (4′) contain aliphatic C—C double or triple bonds which are reactive toward Si—H groups in hydrosilylation reactions and add these to form Si—C bonds. Compound (4a′) is preferred.

Adding the SiH group in intermediate (5′) onto the double or triple bond in (4a′) or (4b′) results in the formation of isomers which is known to a person skilled in the art.

The —C_{f′}H_{2f′-2k′} group in formula (I′) of polyether-polysiloxane copolymers (B2) according to the present invention encompasses this isomer formation and therefore preferably represents the isomeric moieties —CH₂—CHR^{3′}— of (iii) and H₃C—CR^{3′}— of (iv) and —CR^{4′}═CH— of (v) and R⁴′HC═C— of (vi) (since the organic compounds (4a′) are preferable, the isomeric moieties (iii) and (iv) are preferable), and f′ is therefore the total number of carbon atoms in the H₂C═CR³′ group of (4a′) or the R^{4′}C≡C group of (4b′). Since R^{3′} and R^{4′} are preferably hydrogen atoms, f′ is therefore preferably 2.

A preferred example of the organic compound (4a′) is the compound of the formula

H₂C═CH—CH₂—(OCH₂CH₂)ₐ[OCH₂CH(CH₃) ]_{b}[OCH₂CH(CH₂CH₃)]_{c}—OR³,

and the —C_{f′}H_{2f′-2k′}-Z moiety in (I′) therefore preferably represents the isomeric moieties of the formula

CH₂-CH₂-CH₂-(OCH₂CH₂)_{a′}[OCH₂CH(CH₃)]_{b′}[OCH₂CH(CH₂CH₃)]_{c′}—OR^{3′}

H₃C—CH—CH₂ -(OCH₂CH₂)_{a′}[OCH₂CH(CH₃)]_{b′}[OCH₂CH(CH₂CH₃)]_{c′}—OR^{3′}

where a′, b′, c′ and R^{3′} are each as defined above.

The Z moiety bonded to the double or triple bond in (4a′) or (4b′) is a polyether. They are typically prepared by polymerization of ethylene oxide and/or propylene oxide and/or butylene oxide, in which case the alkylene oxide units can be present either in random distribution or as block copolymers. The polyethers are obtainable from just one alkylene oxide or, via copolymerization, from two or three of the alkylene oxides mentioned. Depending on the method, random copolymers or block copolymers are obtained with randomly distributed polyethers being preferred. The polyethers of formula 4a and 4b which are used for preparing the branched polyether-polysiloxane copolymers (B2) have at least two polyoxyalkylene units but typically not more than 200 polyoxyalkylene units and preferably not more than 150 polyoxyalkylene units.

The organic compound (4′) is used in the second process step in amounts such that the ratio of aliphatic double bonding in (4a′), or of aliphatic triple bonding in (4b′), to Si-attached hydrogen in the intermediate (5′) obtained in the first process step is preferably in the range from 1.05 to 1.5.

The amounts in which catalyst (3′) is used in the second process step are preferably in the range from 0.5 to 50 wt ppm (parts by weight per million parts by weight) and more preferably in the range from 2 to 20 wt ppm, all reckoned as elemental platinum and based on the overall weight of organic compound (4′) and intermediate (5′) obtained in the first process step.

The second process step is preferably carried out at ambient pressure, i.e., approximately at 1020 hPa (abs.), but can also be carried out at higher or lower pressures. Furthermore, the first process step is preferably carried out at a temperature of 20° C. to 150° C. and more preferably 40° C. to 120° C.

The branched polyether-polysiloxane copolymers (B2) and their preparation are described in EP 1 424 117 A2, especially page 2 line 41 to page 10 line 19 (incorporated by reference).

Preference for use as branched polyether-polysiloxane copolymers is given to polyether-polysiloxane copolymers (B3) of the general formula

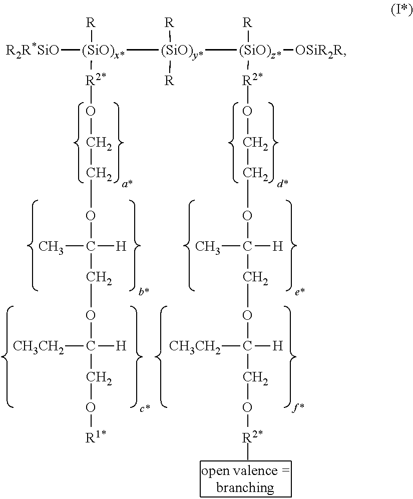

where R is as defined above,
R* is either R or one of the groupings -R^{2*}-(CH₂CH₂O)_{a*}[CH₂CH(CH₃)O]_{b*}[H₂CH(CH₂CH₃)O]_{c*}—OR^{1*} or -R^{2*}-(CH₂CH₂O)_{d*}[CH₂CH(CH₃)O]_{e*}[H₂CH(CH₂CH₃)O]_{f*}—R^{2*}- and R^{1*} is either hydrogen or an alkyl, aralkyl, aryl or R-C(O) moiety,
x* is from 0.1 to 200,
y* is from 1 to 1000 and
z* is from 0.01 to 2.0,
a*, b*, c*, d*, e* and f* are each between 0 and 1000 with the proviso that the sum of (a*+b*+c*) and the sum of (d*+e*+f*) is from 2 to 2000,
and R^{2*} is an alkylene moiety of 2 to 10 carbon atoms and the open valence is again linked to one of the

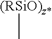

groupings of a polyether-polysiloxane copolymer of the general formula (I*).

Preferably, in the polyether-polysiloxane copolymer of the general formula (I), a* and b* are each between 5 and 50, c*, d* and f* are each 0, e* is from 20 to 150, x* is from 1 to 10, y* is from 3 to 100 and z* is from 0.5 to 1.5.

R* is preferably R.

Examples of R moieties are specified above.

The room temperature liquid polyether-polysiloxane copolymers of the general formula (I*) are prepared for example by reacting

(ba) organosilicon compounds of the general formula,

(R₂R**SiO)₂(HRSiO)_{x*-z*}(R₂SiO)_{y*} (III*)

where R, x*, y* and z* are each as defined above and R** is either R or H,
(bb) organic compounds of the general formula

R^{1*}—O—(CH₂CH₂O)_{a*}[CH₂CH(CH₃)O]_{b*}[CH₂CH (CH₂CH₃) O]_{c*}-R^{5*} (IV*)

and
(bc) organic compounds of the general formula

R^{5*}—O—(CH₂CH₂O)_{d*}[CH₂CH(CH₃) O]_{e*}[CH₂CH(CH₂CH₃) O]_{f*}-R^{5*} (V*)

where R^{1*}, a*, b*, c*, d*, e* and f* are each as defined above,
R^{5*} is an alkenyl group of the formula —C_{m*}H_{(2m*-1)} with 2 to 10 carbon atoms, where m* is from 3 to 10 and preferably equal to 3, and R^{5*} is preferably a vinyl or allyl group, wherein the ratio of the number of Si—H functions in formula (III*) to the number of alkenyl groups R^{s*} in the formulae (IV*) and (V*) is not more than 1, in the presence of a catalyst that promotes hydrosilylation reactions.

Compounds of the general formula (III*) are flowable siloxanes, the viscosity of which is determined by the totaled average number of HRSiO and R₂SiO groups in the molecule. These compounds and their synthesis are common general knowledge. For example, the hydrogen-functional polyorganosiloxanes of the general formula (III*) where the H—Si bonds form a random distribution are obtainable by co-hydrolysis of methylchlorosilanes, for example from MeSiHCl₂, Me₂SiHCl, Me₂SiCl₂, Me₃SiCl and MeSiCl₃. It is further possible to obtain hydrogen-functional polyorganosiloxanes by acidic equilibration of hexamethyldisiloxane and mixtures of various cyclics, for example cyclic methylhydrogensiloxanes and cyclic dimethylsiloxanes, or by equilibration of linear oligomeric and/or polymeric siloxanes, in which case one reactant has lateral and optionally also terminal Si—H groups.

The sum (x*+z*) in the general formula (III*) is for example between 1.1 and 202 and preferably between 1.5 and 11.5. The -HRSiO- groups therein are randomly distributed over the molecule. The y* value in the general formula (III*) is preferably in the range from 1 to 1000 and more preferably in the range from 3 to 100.

The organic compounds of the general formulae (IV*) and (V*) are referred to as polyethers or polyoxyalkylenes. This group of compounds is known. They are typically prepared by polymerization of ethylene oxide and/or propylene oxide and/or butylene oxide, in which case the alkylene oxide units can be present either in random distribution or as block copolymers. The polyethers of the general formulae (IV*) and (V*) are obtainable from just one alkylene oxide or, via copolymerization, from two or three of the alkylene oxides mentioned. Depending on the method, random copolymers or block copolymers are obtained with randomly distributed polyethers being preferred. The polyethers of general formulae (IV*) and (V*) which are used for preparing the polyether-polysiloxane copolymers (B3) have at least two polyoxyalkylene units but typically not more than 200 polyoxyalkylene units and preferably not more than 150 polyoxyalkylene units. The R^{1*} moiety in the general formulae (I*) and (IV*) is, for example, ethyl, n-propyl, i-propyl, hexyl, decyl, dodecyl, 2-phenylethyl, preferably hydrogen, methyl, butyl and acetyl.

The weight fractions which are used of the compounds (III*), (IV*) and (V*) in the preparation are selected as a function of the desired polyether-polysiloxane copolymer of the general formula (I*) and are a simple means for the average molecular weight and the viscosity to be policed, and appropriately adjusted to the desired requirements, by a person skilled in the art. The weight fractions used of compound (IV*) and compound (V*) and the molecular ratios fixed thereby determine the coefficients x* and z* in the general formula (I*).

The compounds of the general formulae (III*), (IV*) and (V*) are reacted in the presence of hydrosilylation catalysts, while the ratio of the number of Si-H groups in the compound of the general formula (III*) to the number of terminal alkylene groups coming from the compounds of the general formulae (IV*) and (V*) is not more than one. When the compounds of the general formulae (III*), (IV*) and (V*) are not miscible with one another, or the mixing viscosity is too high, it is sensible to use a solvent or solubilizer. Preference for use is given to aprotic solvents, for example benzene, xylene or saturated hydrocarbons, but especially aromatic solvents, such as toluene.

Examples of hydrosilylation catalysts are described among the abovementioned catalysts (3).

Hydrosilylation catalysts are used in concentrations of 0.1 to 100 ppm, preferably 2 to 50 ppm and more preferably from 4 to 20 ppm, based on the total amount of starting materials.

The temperatures during the preparation of polyether-polysiloxane copolymers are up to 300° C. Temperatures in the range from 50 to 120° C. are preferred. The reaction time is between 1 min and 20 h. The degree of conversion can be determined via the amount of alkali-detachable hydrogen from unconverted Si—H groups. The reaction has ended once no detachable hydrogen is detectable, or the concentration of remaining hydrogen cannot be reduced any further.

The polyether-polysiloxane copolymers (B3) and their preparation are described in EP 1 076 073 A1, especially at page 2 line 38 to page 4 line 46 (incorporated by reference).

Deaeration for the purposes of this invention is a process wherein the gas content of a liquid which contains gas in dispersed form, i.e., which contains a microfoam where the volume fraction of liquid is higher than the volume fraction of gas, is reduced.

A method for deaerating liquids for the purposes of this invention is more particularly a method wherein the gas content of a liquid phase containing preferably not more than 50% by volume, more preferably not more than 20% by volume and even more preferably not more than 10% by volume of gas in dispersed form is reduced significantly in that preferably a gas content below 5% by volume and especially below 2% by volume is achieved.

The invention preferably provides a method for deaerating the liquids generated in chemical-pulp production, preferably aqueous suspensions.

Chemical pulp, which is cellulose plus a varying level of impurities, is recovered from cellulose-containing materials, such as wood, using different destructurizing solutions in order to dissolve the other constituents, such as lignin. This is followed by a washing and sieving process in which the pulp obtained is separated from the destructurizing solution and purified.

The alkaline sulfate or kraft process, wherein the so-called sulfate or kraft pulp is obtained using an NaOH/NaS-containing destructurizing solution, is arguably the most important method of destructurization. Black liquor which, in addition to the destructurizing solution, contains the remaining constituents of the cellulose-containing material, such as wood, is generated as further product.

The silicone polyethers of the present invention can be used directly or, on account of the better distribution and handling, as a solution in suitable organics or as an emulsion.

Suitable organics to be added are mineral oils, natural oils, isoparaffins, polyisobutylenes, residues from the oxo alcohol process, esters of low molecular weight synthetic carboxylic acids, e.g., 2,2,4-trimethyl-1,3-pentanediol diisobutyrate, fatty acid esters, e.g. dodecyl palmitate or isopropyl myristate, fatty alcohols, phthalates and esters of phosphoric acid.

Preparing the Inventive polyether-polysiloxane Copolymers:
Preparing the polyether-polysiloxane Copolymer (polymer 1) as Described in WO 2006/128624 A1:

67 g of a siloxane composed of dimethylsiloxy and hydrogenmethylsiloxy units and terminated with methyl groups and having an active hydrogen content of 0.133% and a viscosity of 72 mm²/s (25° C.) are mixed with 408 g of an allyl polyether (560 ppm H₂O content) having a PO/EO ratio of 4.0 and an iodine number of 11.2, and heated to 100° C., under vigorous agitation. A 0.5 ml quantity of a 2% solution of hexachloroplatinic acid in isopropanol is added to initiate the hydrosilylation, evident from a weakly exothermic reaction. The reaction mixture is maintained at 100 to 110° C. until a clear copolymer is obtained and active hydrogen is no longer detectable. The intermediate, a polysiloxane having lateral polyether groups (polymer V1 in comparative test 2), has a viscosity of 870 mm²/s (25° C.)

Heating is continued to 130° C. to remove traces of water at 1 hPa. Thereafter, 7 g of hexamethylene diisocyanate are metered in before the mixture is homogenized for 20 minutes. The isocyanate reaction is initiated using one drop of dibutyltin laurate (DBTL). After two hours, the NCO content has dropped to below the limit of detection (IR: 20 ppm), so that 120 g of a surfactant (commercially available under the designation Emulan® HE 50 from BASF SE, Ludwigshafen, Germany) are metered in. The 80% copolymer solution is cooled down to 25° C. and has a viscosity of 2100 mm²/s and a urethane content of 0.139 meq/g.

Preparing the polyether-polysiloxane Copolymer (polymer 2) as Described in EP 1 076 073 A1:

1 mol of Si—H-containing siloxane polymer of the formula (Me₃SiO)₂(HRSiO)₅(Me₂SiO)₅₀, 4.25 mol of monoallyl polyether of the formula C₄H₉—O—(CH₂CH₂O)₂₅[CH₂CH(CH₃)O]₂₅-CH₂-CH═CH₂ and 1 mol of diallyl polyether of the formula CH₂═CH—CH₂—O—[CH₂CH(CH₃)O] ₁₃₀—CH₂—CH═CH₂ are mixed in toluene as solvent. This mixture is refluxed for three hours in the presence of 10 ppm (reckoned as platinum) of Speier's catalyst. The solvent is removed under reduced pressure (100 Pa). Less than 5 ppm of alkali-detachable hydrogen is detectable in the products obtained.

Preparing the polyether-polysiloxane Copolymer (polymer 3) as Described in EP 1 424 117 A2:

In a glass flask equipped with mechanical stirrer, 108 g of 1,2,4-trivinylcyclohexane are mixed with 1840 g of an α,ω-dihydrogenpolydimethylsiloxane having an active hydrogen (Si-attached hydrogen) content of 0.18 wt % and a viscosity of 9 mPa·s at 25° C. and then admixed with 1.9 g of a solution of a platinum-1,3-divinyl-1,1,3,3-tetramethyldisiloxane complex in dimethylpolysiloxane (Karstedt's catalyst) having a Pt content of 1.0 wt %. The reaction mixture heats up to about 80° C. within a few minutes and is stirred at about 80° C. for about one hour to obtain a branched siloxane polymer having a viscosity of 220 mm²/s at 25° C. and an active hydrogen content at 0.067 wt %. In accordance with the principle of their synthesis, all free siloxane chain ends consist of highly reactive hydrogendimethylsiloxy units.

100 g of this hydrogensiloxane polymer are metered into a hot mixture at 100° C. of 226 g of a monoallylic polyether having on average 24 ethyleneoxy and 25 propyleneoxy groups of the formula CH₂═CH—CH₂—O—(CH₂CH₂O)₂₄-(CH₂CH₂CH₂O)₂₅—H and 0.3 g of the Karstedt catalyst solution described in example 1 (Pt content=1.0 wt %). After altogether three hours' reaction time, the active hydrogen (Si-attached hydrogen) has been completely converted. Cooling down to 25° C. gives a clear, very viscous product with 18 400 mPa·s at 25° C. The free chain ends are modified with linear polyether chains.

Comparative polymer (polymer V1):

Polymer V1 is the intermediate stage in the preparation of polymer 1. It is an unbranched polysiloxane having lateral polyether groups similar to GB 2 350 117 A.

### Silicone Oil A1:

94 parts of polydimethylsiloxane having a viscosity of 12 500 mm²/s and 6 parts of a hydrophilic silica are homogenized three times using a colloid mill (0.6 mm gap). The silica is hydrophobicized in situ by heating the mixture to 190° C. for 10 hours.

### Description of Deaeration Tests:

350 ml of black liquor from the chemical-pulp process proceeding from hard- and softwood (from UPM Kymmene Oy aus Kuusankoski, Finland) are heated under agitation in a glass beaker to 80° C. under constant conditions for 15 minutes, and then 220 ml thereof are transferred into a stirred glass autoclave likewise thermostatted to 80° C.

### Determination of D₀:

The autoclave is sealed without any addition of deaerator and, following a delay time of 3 seconds, the outlet valve at the base of the autoclave is opened for 5 seconds.

The black liquor is then discharged under 3 bar pressure into a graduated cylinder for immediate determination thereafter of the mass and the volume to compute the density.

### Determination of D₂:

The autoclave is sealed without addition of any deaerator and the contained black liquor is stirred at 800 rpm for 10 minutes under a compressed-air pressure of 3 bar. Following a delay time of 3 seconds, the outlet valve at the base of the autoclave is opened for 5 seconds.

The black liquor is then discharged under 3 bar pressure into a graduated cylinder for immediate determination thereafter of the mass and the volume to compute the density.

### Determination of D₁:

The autoclave is sealed after the deaerator quantity reported in the table below has been added and the contained black liquor is stirred at 800 rpm for 10 minutes under a compressed-air pressure of 3 bar. Following a delay time of 3 seconds, the outlet valve at the base of the autoclave is opened for 5 seconds.

The black liquor is then discharged under 3 bar pressure into a graduated cylinder for immediate determination thereafter of the mass and the volume to compute the density.
D₀=Density of black liquor at 80° C. without deaerator; without agitation
D₂ =Density of black liquor at 80° C. without deaerator; after agitation
Density of black liquor at 80° C. with deaerator; after agitation

Deaeration in %=100×(D₁−D₂)/(D₀−D₂)
D₀ (hardwood): 1.02 g/cm³ and D₂ (hardwood): 0.87 g/cm3.
D₀ (softwood) : 1.04 g/cm³ and D₂ (softwood): 0.79 g/cm³.

### Examples 1 to 3 (with polymers 1 to 3),

Comparative Test 1 (with polymer 1+silicone oil A1) and
Comparative Test 2 (with polymer V1):

To prepare them for use as deaerators, the polymers A1 to A3 (examples 1-3) and polymer V1 (comparative test 2) are each dissolved as a 20% solution in a synthetic ester, 2,2,4-trimethyl-1,3-pentanediol diisobutyrate.

What is used as a deaerator in comparative test 1 is a defoamer formulation as described in WO 2006/128624 A1, which contains the above-described silicone oil A1 as well as the branched polyether-polysiloxane copolymer (polymer 1).

In comparative test 1, the 20% solution contains 2% of polymer 1 and 18% of the above-described silicone oil A1 (in accordance with example 1 (C11) of WO 2006/128624 A1).

The amounts added to the black liquor of the 20% solutions and of the pure ester (as blank sample) are reported in the table.

The results of the deaeration efficacy testing are summarized in the table.

TABLE

| | | | Deaeration | Deaeration |
|---|---|---|---|---|
| | | | in | in |
| | | | black | black |
| | | | liquor | liquor |
| Examples/ | | Amount | from | from |
| Comparative | | added | hardwood | softwood |
| tests | Deaerator | in μl | in % | in % |
| Example 1 | Polymer 1 | 20 | 61.2 | 86.0 |
| | (WO2006/128624) | | | |
| Comparative | Polymer 1 + | 20 | 42.8 | 63.7 |
| test 1 | silicone oil | | | |
| (defoamer) | A1 | | | |
| | (WO2006/128624) | | | |
| Example 2 | Polymer 2 | 20 | 55.4 | 77.3 |
| | (EP1076073A) | | | |
| Example 3 | Polymer 3 | 20 | 53.0 | 72.2 |
| | (EP1424117A) | | | |
| Comparative | Polymer V1 | 20 | 42.4 | 67.0 |
| test 2 | | | | |
| (unbranched | | | | |
| polymer) | | | | |
| Blank test | Solvent: | 16 | 18.0 | 31.0 |
| | 2,2,4- | | | |
| | trimethyl-1,3- | | | |
| | pentanediol | | | |
| | diisobutyrate | | | |

As is apparent from the table, deaeration is distinctly worse in comparative test 1 than in example 1. Comparative test 1 utilizes a defoamer as described in WO 2006/128624 A1, which contains a silicone oil as well as the branched polymer 1. The defoamer described in WO 2006/128624 A1 is thus not suitable for use as a deaerator. Surprisingly, by contrast, the branched polyether-polysiloxane copolymer is on its own useful as a deaerator.

Deaeration is also distinctly worse in comparative test 2 than in example 1. Comparative test 2 utilizes an unbranched polyether-polysiloxane copolymer similar to GB 2 350 117 A. The branched polyether-polysiloxane copolymer of the present invention, by contrast, shows an unexpectedly superior result in deaeration.

1. A method for deaerating a liquid comprising addition of 0.0001 to 5.0 wt %, of branched polyether-polysiloxane copolymers to the liquid, wherein the polyether moieties of the polyether-polysiloxane copolymers are attached to linear siloxane chains via hydrocarbon moieties in SiC bonding and these siloxane chains are connected to each other via SiC-bonded two- to ten-valent hydrocarbon moieties which may contain one or more heteroatoms selected from the group consisting of oxygen and nitrogen atoms.

2. The method as claimed in claim 1, wherein the branched polyether-polysiloxane copolymers have linear siloxane chains connected to each other via lateral linear or branched SiC-bonded organic moieties or have linear siloxane chains connected to each other terminally via branched organic moieties.

3. The method as claimed in claim 1, wherein the branched polyether-polysiloxane copolymers have siloxane chains connected to each other via lateral divalent SiC-bonded hydrocarbon moieties that contain polyether moieties and urethane groups.

4. The method as claimed in claim 1, wherein the branched polyether-polysiloxane copolymers are obtained
by a first step of reacting linear organopolysiloxanes (1), which have at least one Si-attached hydrogen atom per molecule, with substantially linear oligomeric or polymeric compounds (2) of the general formula
R¹-(O—CₙH₂ₙ)ₘ-A¹—H (I)
where R¹ is a monovalent optionally substituted hydrocarbon moiety onto which Si—H groups may be added in a hydrosilylation reaction,
A¹ is a divalent polar organic moiety selected from the group consisting of —O—, —NH— and —NR′— (where R′ is a monovalent hydrocarbon moiety with 1 to 18 carbon atoms),
n is an integer from 1 to 20, and
m is a positive integer,
and a second step of
reacting the thus obtained H—A′-containing intermediates (4) with organic compounds (5) having at least two isocyanate groups per molecule,
with the proviso that the water content of said compounds (1) and (2) used for preparing the polyether-polysiloxane copolymers is less than 2000 wt ppm, based on the overall weight of compounds (1) and (2).

5. The method as claimed in claim 4, wherein said compounds (2) comprise polyethers of the general formula
H₂C═CH—R²-(OCₙH₂ₙ)ₘ—OH (IV)
where R² is a divalent hydrocarbon moiety with 1 to 10 carbon atoms, and
n and m are each as defined in claim 4.

6. The method as claimed in claim 4, wherein said organic compounds (5) comprise diisocyanates of the general formula
O═C═N—R³—N═C═O (V)
where R³ is a divalent hydrocarbon moiety having 4 to 40 carbon atoms per moiety.

7. The method as claimed in claim 1, wherein the branched polyether-polysiloxane copolymers contain structural elements of the general formula
Y[—C_{n′}H_{2n′}—-(R₂SiO)_{m′}—A′_{p′}—R₂Si—G]_{x′} (I′)
where
Y is a three- to ten-valent hydrocarbon moiety which may contain one or more heteroatoms selected from the group consisting of oxygen and nitrogen atoms,
R in each occurrence may be the same or different and is a monovalent optionally halogenated hydrocarbon moiety having 1 to 18 carbon atoms per moiety,
A′ is a moiety of the formula —R₂Si—R^{2′-(R}₂SiO)_{m′}-, where
R^{2′} is a divalent hydrocarbon moiety which has 2 to 30 carbon atoms and which may be interrupted by one or more mutually separate oxygen atoms,
G is a monovalent moiety of the formula —C_{f′}H_{2f′-2k′}—Z or a divalent moiety of the formula —C_{n′H}_{2n′}—, where the second bond goes to a further Y moiety,
Z is a moiety of the formula
(R^{6′})_{v′}—(OCH₂CH₂)_{a′}[OCH₂CH (CH₃)]_{b′}[OCH₂CH (CH₂CH₃)]_{c′}—OR^{3′}
where
R^{3′} is a hydrogen atom or a hydrocarbon moiety with 1 to 18 carbon atoms or a moiety of the formula R—C(O)— (where R is as defined above),
R⁶′ is a divalent hydrocarbon moiety with 1 to 10 carbon atoms,
v′ is 0 or 1,
a′, b′ and c′ are each 0 or an integer between 1 and 1000, with the proviso that the sum of (a′+b′+c′) has a value of 2 to 2000,
x′ is an integer from 3 to 10,
f′ is an integer from 2 to 12,
k′ is 0 or 1,
n′ is an integer from 2 to 12,
m′ is an integer of at least 1,
p′ is 0 or a positive integer,
with the proviso that the branched polyether-polysiloxane copolymers contain on average at least one Z group.

8. The method as claimed in claim 1, wherein the branched polyether-polysiloxane copolymers are of the general formula 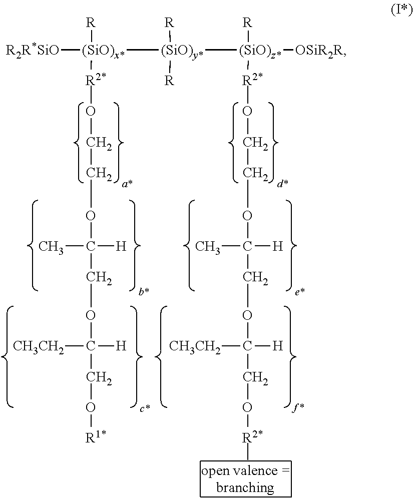
where R in each occurrence represents identical or different, substituted and/or unsubstituted hydrocarbon moieties of 1 to 30 carbon atoms,
R* is either R or one of the groupings
—R^{2*}—(CH₂CH₂O)_{a*}[CH₂CH(CH₃)O]_{b*}[H₂CH (CH₂CH₃)O]_{c*}—OR^{1*} or
—R^{2*}—(CH₂CH₂O)_{d*}[CH₂CH(CH₃)O]_{e*}[H₂CH (CH₂CH₃)O]_{f*}—R^{2*}—
and R^{1*} is either hydrogen or an alkyl, aralkyl, aryl or R—C(O) moiety,
x* is from 0.1 to 200, y* is from 1 to 1000 and z* is from 0.01 to 2.0,
and a*, b*, c*, d*, e* and f* are each between 0 and 1000 with the proviso that the sum of (a*+b*+c*) and the sum of (d*+e*+f*) is from 2 to 2000,
and R^{2*} is an alkylene moiety of 2 to 10 carbon atoms and the open valence is again linked to one of the
(RSiO)_{z*}
groupings of a polyether-polysiloxane copolymer of the general formula (I*).

9. The method as claimed in claim 1, wherein the liquid contains gas in dispersed form, i.e., the liquid contains a microfoam where the volume fraction of liquid is higher than the volume fraction of gas, wherein the method reduces the gas content of the liquid.

10. The method as claimed in claim 1, wherein the liquid is a liquid generated in chemical-pulp production.

11. The method as claimed in claim 1, wherein 0.0002-1.0 wt % of said branched polyether-polysiloxane copolymers is added.

12. The method as claimed in claim 1, wherein 0.001-0.2 wt % of said branched polyether-polysiloxane copolymers is added.

13. The method as claimed in claim 1, wherein the hydrocarbon moieties are two- to four-valent.

14. The method as claimed in claim 2, wherein the branched polyether-polysiloxane copolymers have linear siloxane chains connected to each other via linear SiC-bonded organic moieties.

15. The method as claimed in claim 4, wherein the linear organopolysiloxanes (1) have at least two Si-attached hydrogen atoms per molecule.

16. The method as claimed in claim 5, wherein R² is a moiety of the formula —CH₂—, —CH(CH₃)— or —C(CH₃)₂—.

17. The method as claimed in claim 7, wherein Y is three- to four-valent.
